(19) United States
(12) Patent Application Publication
(10) Pub. No.: US 2023/0125612 A1
(43) Pub. Date: Apr. 27, 2023

(54) FENCE SUPPORT SYSTEM

(71) Applicant: Christopher Andrew Calle, Dallas, TX (US)

(72) Inventor: Christopher Andrew Calle, Dallas, TX (US)

(21) Appl. No.: 18/048,419

(22) Filed: Oct. 20, 2022

Related U.S. Application Data
(63) Continuation of application No. 16/198,751, filed on Nov. 21, 2018, now abandoned.
Application No. 16/198,751 is a continuation-in-part of application No. 15/593,301, filed on May 11, 2017, now Pat. No. 10,927,562.
Application No. 15/593,301 is a continuation-in-part of application No. 15/053,600, filed on Feb. 25, 2016, now Pat. No. 10,465,414.
(60) Provisional application No. 62/335,074, filed on May 12, 2016.
(60) Provisional application No. 62/385,427, filed on Sep. 9, 2016.
(60) Provisional application No. 62/209,750, filed on Aug. 25, 2015.

(51) Int. Cl. E04H 17/04; E04H 17/16; E04H 17/06

(52) U.S. Cl. CPC E04H 17/04; E04H 17/168; E04H 17/161; E04H 17/06; E04H 17/16; F16B 5/0664

(57) ABSTRACT

A fence support system has a catch member comprising a catch plate and a protrusion that extends from the catch plate and a retainer member comprising a retainer plate comprising an aperture, the aperture being configured to receive the protrusion in response to relative movement of at least one of the catch member and the retainer member along an insertion path. When the protrusion is received by the aperture, a curved base portion of the protrusion that does not extend through the aperture is located, as determined along the insertion path, between the catch plate and the retainer plate. The curved base portion is curved angularly about the insertion path.

### CROSS-REFERENCE TO RELATED APPLICATIONS

This patent application is a continuation of U.S. patent application Ser. No. 16/198,751, filed on 21 Nov. 2018 and entitled “FENCE SUPPORT SYSTEM,” which is a continuation-in-part of U.S. patent application Ser. No. 15/593,301, filed on 11 May 2017 and entitled “FENCE SUPPORT SYSTEM,” which claims the benefit of U.S. Provisional Patent Application Ser. No. 62/589,532, filed on 21 Nov. 2017 and entitled “FENCE SUPPORT SYSTEM” and which is a continuation-in-part of U.S. patent application Ser. No. 15/053,600, filed on 25 Feb. 2016 and entitled “FENCE SUPPORT SYSTEM,” which claims the benefit of the filing date of U.S. Provisional Patent Application Ser. No. 62/209,750, filed on 25 Aug. 2015 and entitled “FENCE SUPPORT SYSTEM.” U.S. patent application Ser. No. 15/593,301 also claims the benefit of U.S. Provisional Patent Application Ser. No. 62/335,074, filed on 12 May 2016 and entitled “FENCE SUPPORT SYSTEM” and U.S. Provisional Patent Application Ser. No. 62/385,427, filed on 9 Sep. 2016 and entitled “FENCE SUPPORT SYSTEM.”

The entire content of each of U.S. patent application Ser. No. 16/198,751, U.S. patent application Ser. No. 15/593,301, U.S. patent application Ser. No. 15/053,600, U.S. Provisional Patent Application Ser. No. 62/209,750, U.S. Provisional Patent Application Ser. No. 62/335,074, U.S. Provisional Patent Application Ser. No. 62/385,427, and U.S. Provisional Patent Application Ser. No. 62/589,532 is hereby expressly incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Some flexible fences, such as, but not limited to, apertured fencing and/or safety fencing, is difficult to maintain in good condition and/or to terminate in a structurally beneficial and/or convenient manner.

### BRIEF DESCRIPTION OF THE DRAWINGS

FIG. 1 is an orthogonal view of four fence support systems in use with a perforated fence material, two vertical supports, and four fasteners.

FIG. 2 is a closer orthogonal view of a fence support system in use with a perforated fence material, a vertical support, and a fastener.

FIG. 3 is an orthogonal front view of a fence support system.

FIG. 4 is an orthogonal rear view of the fence support system of FIG. 3.

FIG. 5 is an orthogonal bottom view of the fence support system of FIG. 3.

FIG. 6 is an orthogonal side view of the fence support system of FIG. 3.

FIG. 7 is an oblique front view of a support unit of the fence support system of FIG. 3.

FIG. 8 is an oblique rear view of the support unit of FIG. 7.

FIG. 9 is an oblique rear view of a retainer unit of the fence support system of FIG. 3.

FIG. 10 is an oblique front view of the retainer unit of FIG. 9.

FIG. 11 is a flowchart of a method of supporting a fence.

FIG. 12 is an oblique view of another fence support system in an open configuration.

FIG. 13 is an oblique view of a fence support system in an open configuration and in relation to an apertured safety fence.

FIG. 14 is an oblique view of a fence support system in a closed configuration and attached to an apertured safety fence.

FIG. 15 is an oblique view of a plurality of fence support systems in a variety of configurations and in relation to an apertured safety fence.

FIG. 16 is another oblique view of a plurality of fence support systems in a variety of configurations and in relation to an apertured safety fence.

FIG. 17 is an orthogonal top view of four fence support systems in use with an apertured fence material and four vertical supports.

FIG. 18 is an oblique front view of a catch unit of another fence support system.

FIG. 19 is an oblique front view of a retainer unit of the fence support system of FIG. 17.

FIGS. 20-26 show an alternative embodiment of a fence support system configured for attachment to a T-post.

FIGS. 27-29 show an alternative embodiment of a catch unit comprising D-shaped protrusions and rectangular protrusions.

FIG. 30-32 show an alternative embodiment of a catch unit comprising a post receiver.

FIG. 33 is a top view of a catch member of an alternative embodiment of a fence support system.

FIG. 34 is a side view of the catch member of FIG. 33.

FIG. 35 is another side view of the catch member of FIG. 33.

FIG. 36 is a top view of a retainer member of the fence support system of FIG. 33.

FIG. 37 is a side view of the retainer member of FIG. 35.

FIG. 38 is another side view of the catch member of FIG. 35.

FIG. 39 is a side view of the fence support system of FIG. 33 prior to assembly and showing an insertion path along with directional arrows indicating directions of movement to achieve assembly.

FIG. 40 is a side view of the catch member of FIG. 33 showing a protrusion of the catch member received through an aperture of an apertured fence material.

FIG. 41 is another side view of the catch member of FIG. 33 showing a protrusion of the catch member received through an aperture of an apertured fence material.

FIG. 42 is a side view of the fence support system of FIG. 33 as assembled and capturing an apertured fence material.

FIG. 43 is another side view of the fence support system of FIG. 33 as assembled and capturing an apertured fence material.

### DETAILED DESCRIPTION

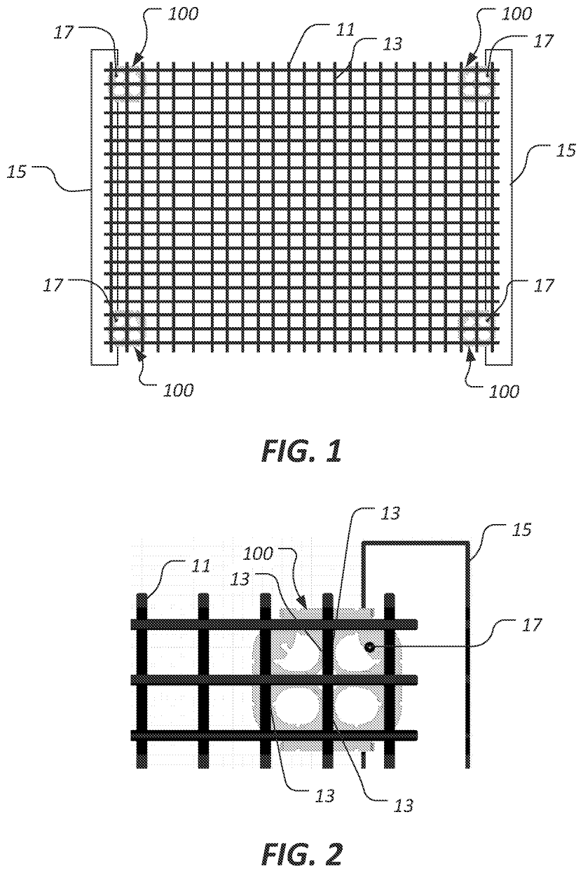

Referring now to FIG. 1, an orthogonal front view of portions of four fence support systems 100 are shown in use with an apertured fence material 11. In this embodiment, the fence material 11 comprises a grid of material pieces that together define apertures 13. In some cases, the fence material 11 may be of the sort commonly referred to as plastic security fencing, safety fencing, and the like. In alternative embodiments, the fence material 11 may comprise any other suitable shape of apertures or arrangement of spacing of apertures relative to each other so that any other suitable matrix, array, or geometric organization of apertures may be provided. In still other embodiments, the apertured fence material may be substantially a solid sheet of material with only so many apertures as necessary to complement the later described protrusions of the fence support systems 100. In this embodiment, the fence support systems 100 are connected to a vertical support 15, such as, but not limited to, a wooden post, through the use of a fastener 17. In this embodiment, the fastener comprises a nail, however, in alternative embodiments, the fastener 17 may comprise a screw, a bolt, a zip tie, a wire, or any suitable fastener, fixed point, or semi-permanently fixed point.

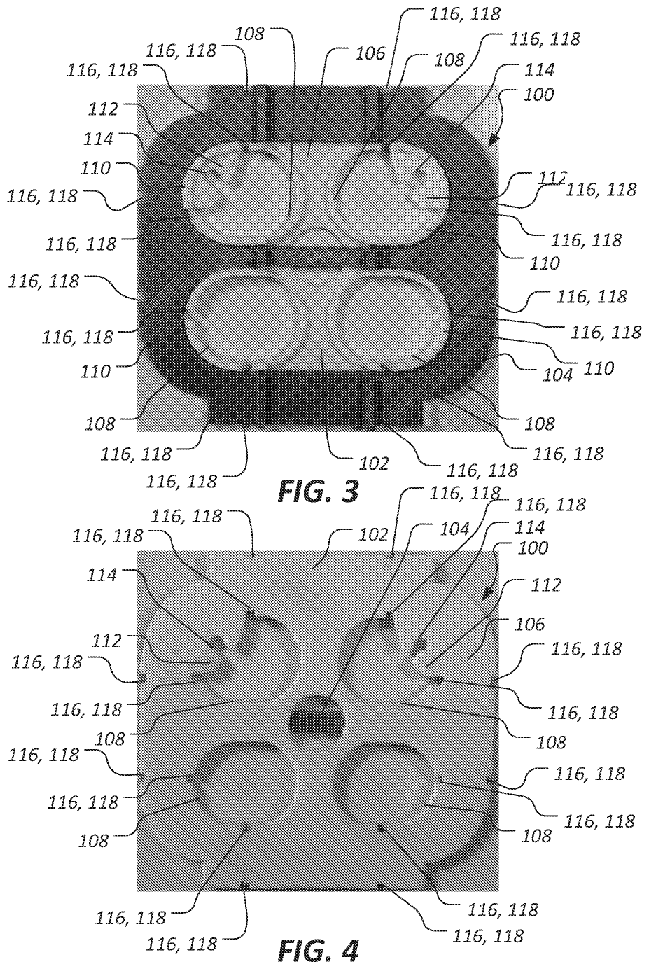

Referring now to FIG. 2, a closer orthogonal front view of a fence support system 100 is shown in greater detail. While the fence support system 100 comprises a catch unit 102 and a retainer unit 104, only the catch unit 102 is shown in use with the fence material 11. As shown, the fence support system engages four apertures 13 of the fence material 11.

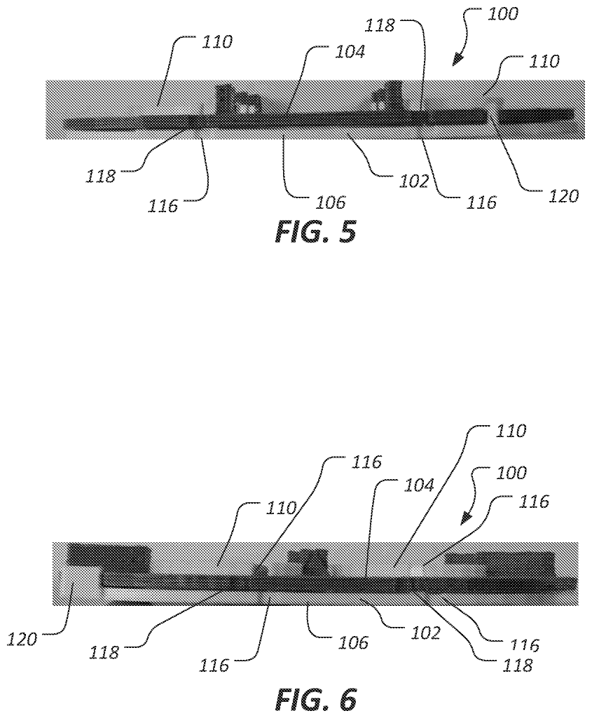

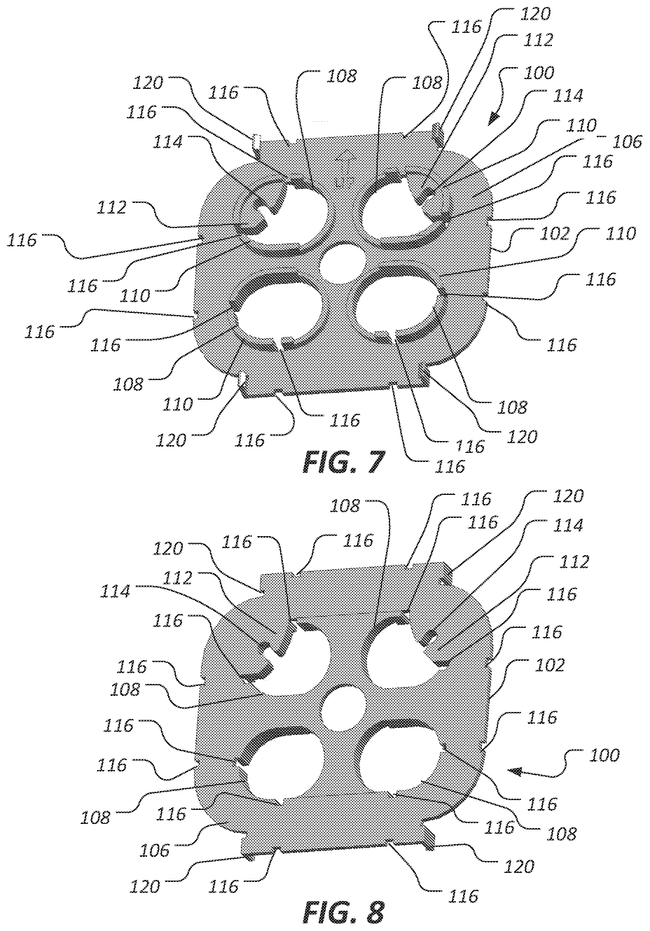

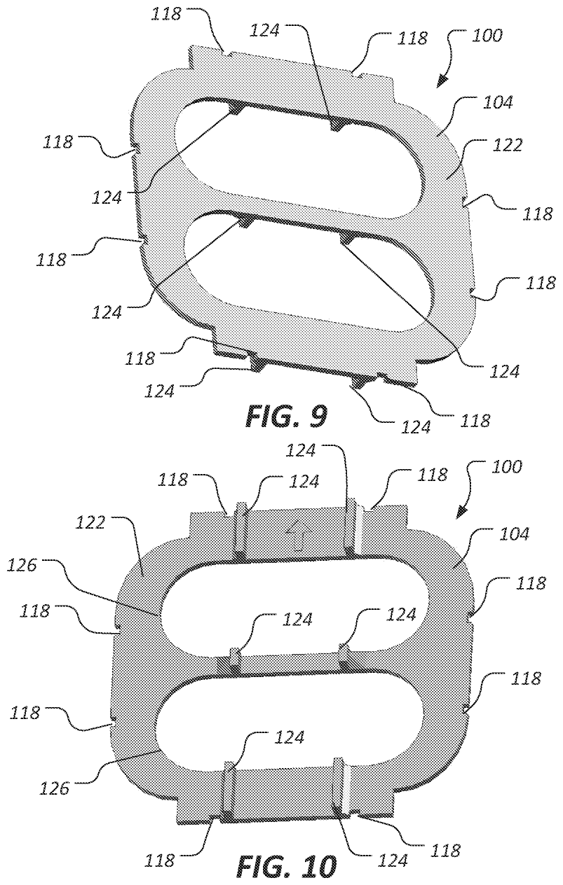

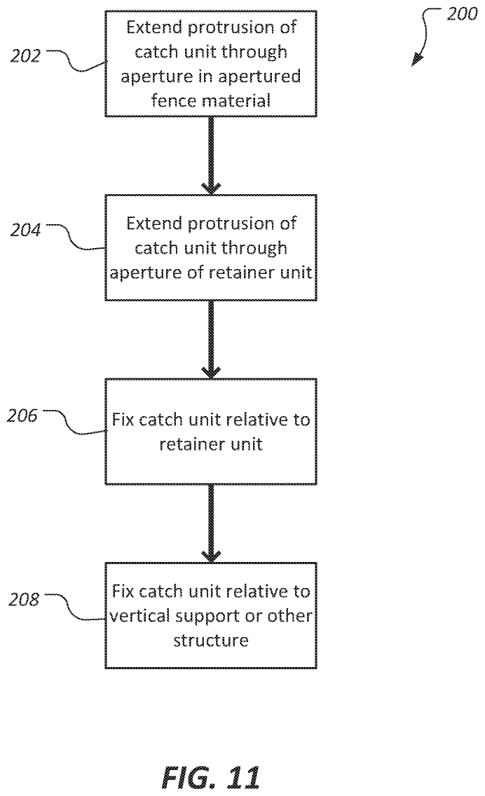

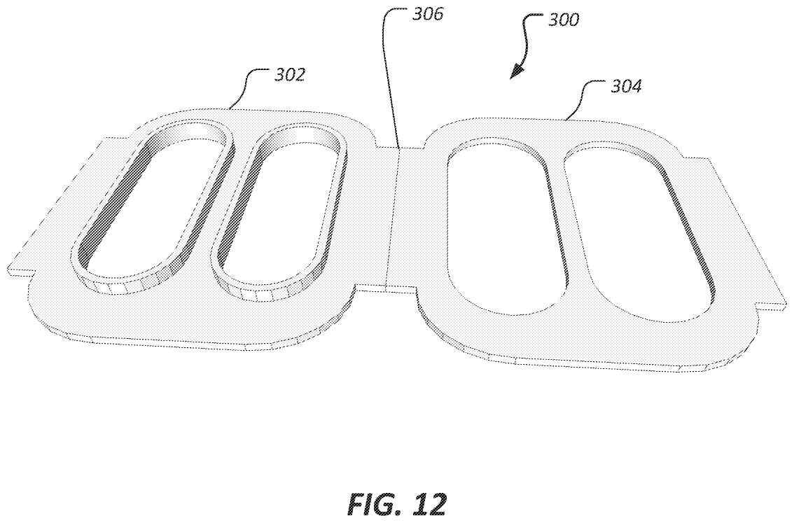

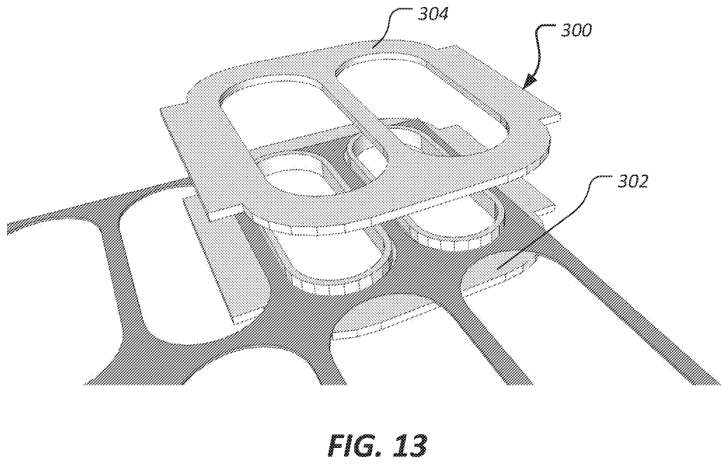

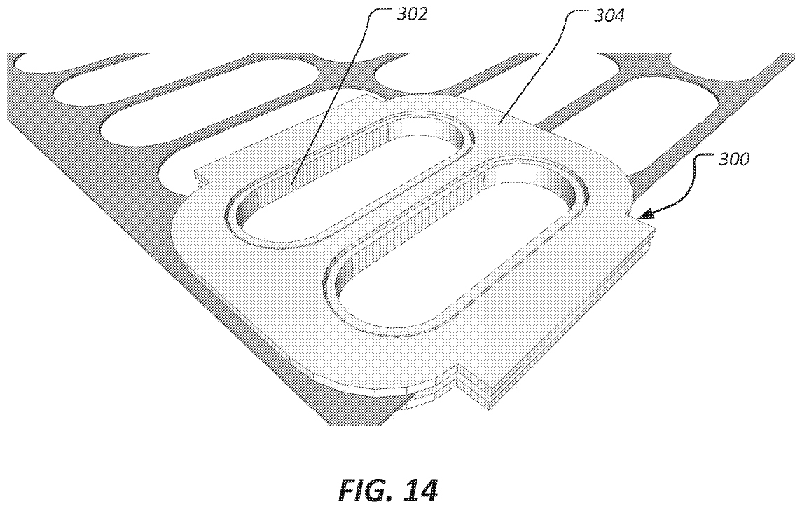

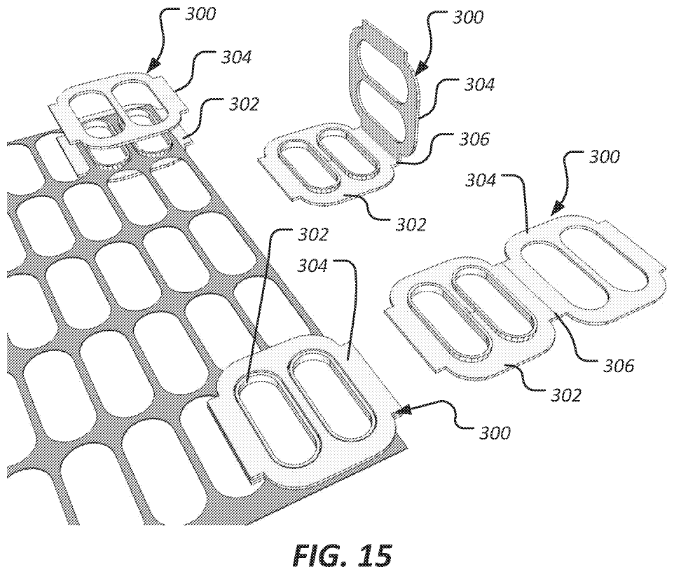

Referring now to FIGS. 3-10, a fence support system 100 is shown in greater detail. In this embodiment, each fence support system 100 comprises a catch unit 102 and a retainer unit 104. Most generally, the catch unit 102 is configured to comprise a catch plate 106 comprising apertures 108. In some cases, the apertures 108 may be shaped complementary to apertures 13 of fence material 11. However, in alternative embodiments, the catch plate 106 may not comprise apertures sized to complement the apertures 13. The catch plate 106 further comprises protrusions 110 sized, shaped, and/or configured relative to each other to complement one or more apertures 13. In this embodiment, the protrusions 110 extend forward from a front of the catch plate 106. The protrusions 110 generally comprise a substantially continuous raised wall that closely borders and/or at least partially forms a boundary of the apertures 108. In this embodiment, two of the apertures 108 are at least partially defined and/or obstructed by a mount tab 112 comprising a mount channel 114. The mount tabs 112 generally extend toward a center of the aperture from at least one of the catch plate 106 and/or protrusions 110. The mount channel 114 is disposed so that an opening is formed in the mount tab 112 and the opening is configured to receive a fastener 17 therein. In some embodiments, the mount channel 114 may be oriented relative to a prescribed use orientation of the fence support system 100 so that the mount channels 114 generally extend in both upward and away from a center of the fence support system 100. In this embodiment, tie notches 116 of the catch unit 102 and the complementarily disposed tie notches 118 of the retainer unit 104 are provided to accept closure devices, such as, but not limited to, zip ties, wires, string, rope, and the like to provide a primary or secondary selective joinder between the catch unit 102 and the retainer unit 104. In other words, when catch unit 102 and retainer unit 104 are mated as shown in FIGS. 3 and 4, zip ties and/or other devices can be passed through geometrically opposing notches 116 and tightened to selectively lock the catch unit 102 and retainer unit 104 relative to each other. In use, the zip ties and/or other devices would typically be applied after sandwiching fence material 11 between the catch unit 102 and the retainer unit 104. In this embodiment, the catch unit 102 further comprises one or more hooks 120 protruding forward beyond the catch plate 106. The hooks 120 are generally configured to selectively engage and/or retain a portion of the retainer unit 104. In this embodiment, the hooks 120 are formed integrally with the catch plate 106 and are inherently spring biased as a function of the material elasticity of the hooks 120 and catch plate 106. In this embodiment, retainer unit 104 comprises a retainer plate 122, walls 124 for capturing a post, such as, but not limited to, a standard T-post between left-right opposing walls 124, and the previously described notches 118. The retainer unit further comprises apertures 126 configured to receive two protrusions 110 through each aperture 126. In alternative embodiments, the protrusions 110 may comprise concave channels formed on an exterior wall of the protrusions 110. In some cases, the concave channels can assist in retaining fencing material 11 relative to the protrusions. In other alternative embodiments, the protrusions may comprise features configured to allow one or more of an interference fit between the protrusions 110 and the apertures 126 and a snap fit between the protrusions 110 and the apertures 126, in some cases, thereby reducing any need for the above-mentioned hooks 120.

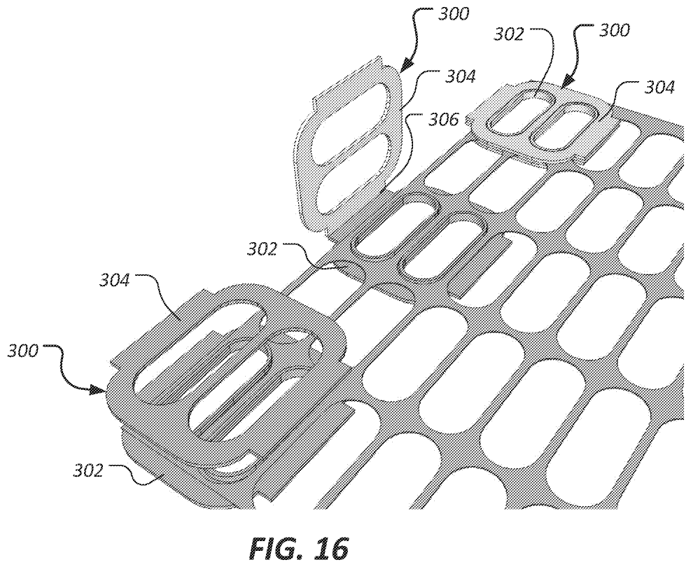

Referring now to FIG. 11, a flowchart of a method 200 of supporting a fence is shown. The method 200 may begin at block 202 by extending a protrusion 110 of the catch unit 102 through an aperture 13 of apertured fence material 11. The method 200 may continue at block 204 by further extending the protrusion 110 through an aperture 126 of the retainer unit. The method 200 may continue at block 206 by fixing the catch unit 102 relative to the retainer unit 104. In some embodiments, the fixing of the catch unit 102 relative to the retainer unit 104 may comprise utilizing zip ties or other devices with notches 116,118, an interference fit between the protrusion 110 and the aperture 126, and/or a snap fit between the protrusion 110 and the aperture 126. The method 200 may continue at block 208 by vertically supporting the catch unit 102, retainer unit 104, and/or the apertured fence material 11 to a vertical support 15 or any other suitable device or structure.

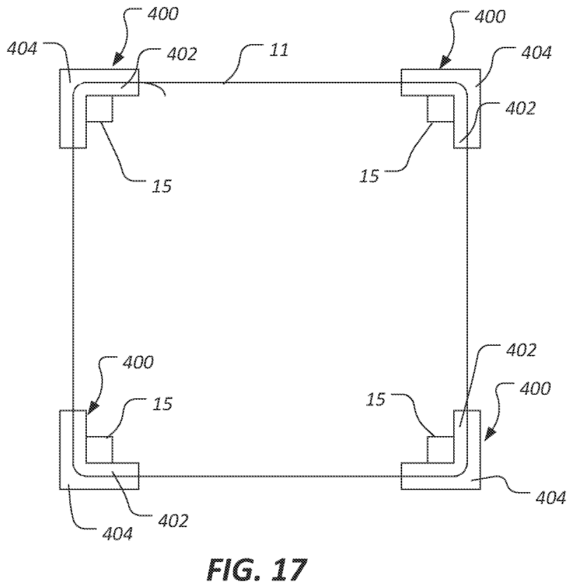

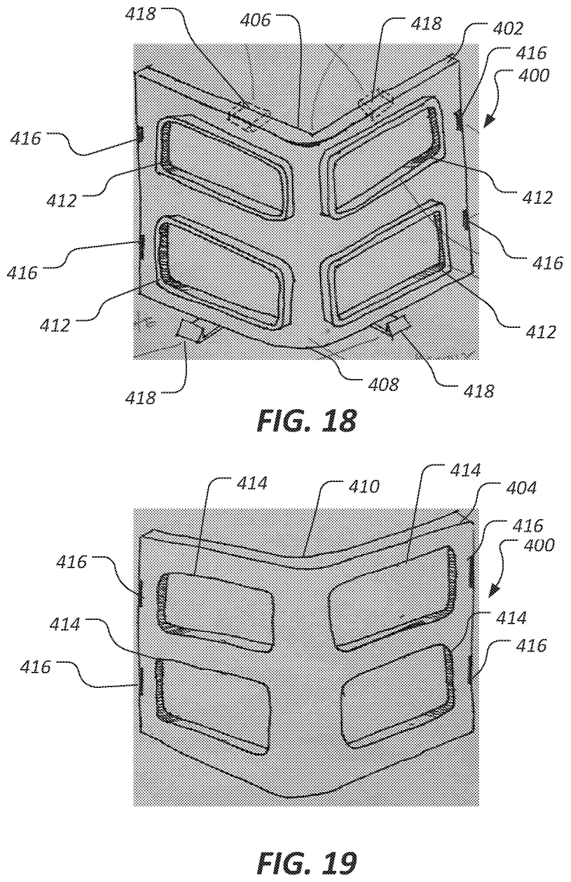

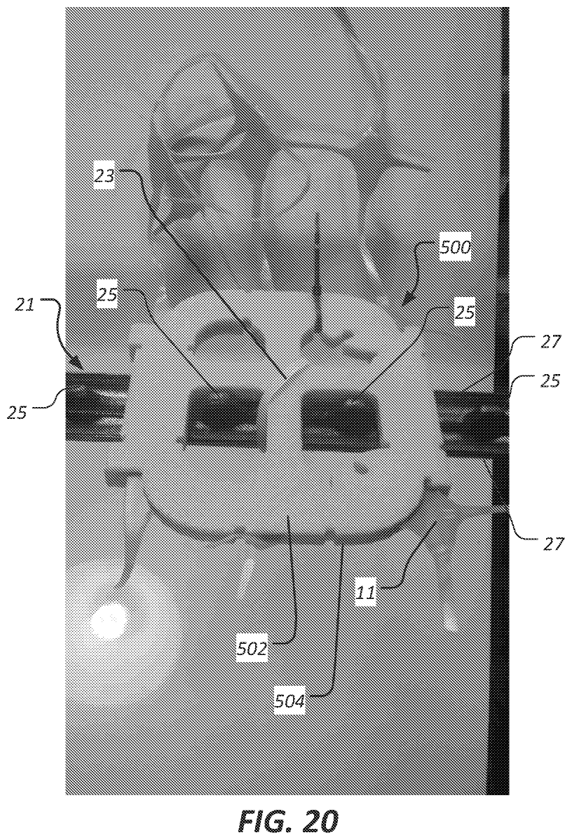

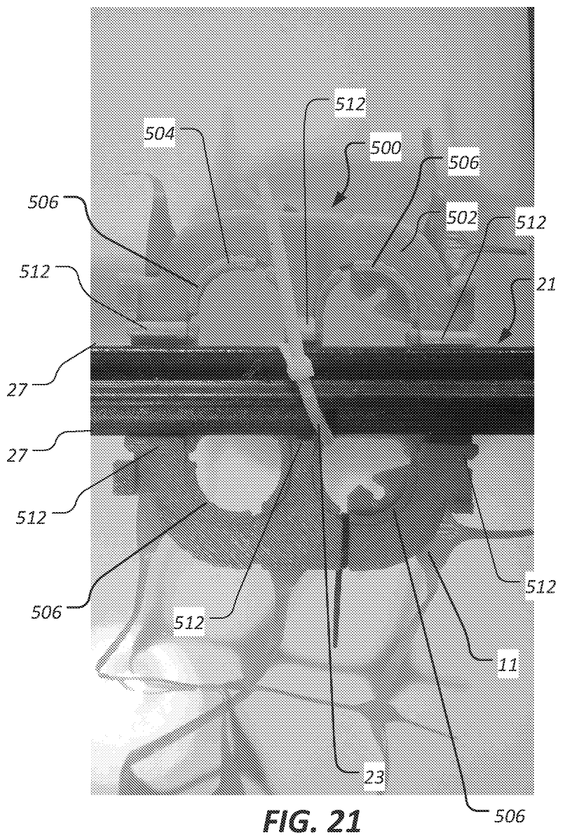

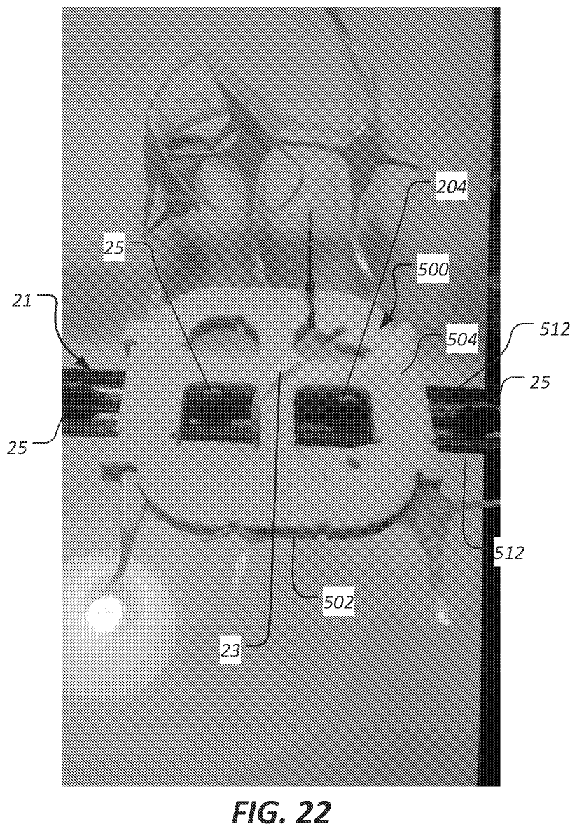

Referring now to FIGS. 12-16, an alternative embodiment of a fence support system 300 is disclosed. The fence support system 300 generally comprises a catch member 302 comprising protrusions configured to complement an aperture shape of an apertured fence material. The fence support system 300 further comprises a retainer member 304 configured to complement the catch member 302 so that the protrusions of the catch member 302 can be securely received and selectively retained within apertures of the retainer member 304. In some embodiments, the protrusion of the catch member 302 can be received through the apertures of an apertured fence material and further received into the apertures of the retainer member 304 so that the apertured fence material is sandwiched between the catch member 302 and the retainer member 304. In some cases, the apertured fence material can be handled by the attached fence support system 300. In some cases, the fence support system 300 can distribute forces to the aperture fence material in a relatively more distributed manner as compared to handling the aperture fence material without a fence support system 300 applied and/or attached. Accordingly, a fence comprising the apertured fence material can last longer and be handled more conveniently. In some embodiments, the catch member 302 is movably attached to the retainer member 304 via a hinge 306. While the apertures and protrusions shown are substantially oval-shaped, in alternative embodiments, the protrusions may alternatively be formed complementary to any other shape and/or pattern of shapes configured to complement the shapes and/or patterns of apertures of apertured safety fences. In still other embodiments, the protrusions may alternatively be formed without respect to a shape and/or pattern of shapes of an apertured fence material but may nonetheless be sized relative to one or more apertures of the apertured fence material so that the protrusion can be inserted into an aperture, even if the apertured fence material must be stretched to accommodate the protrusion.

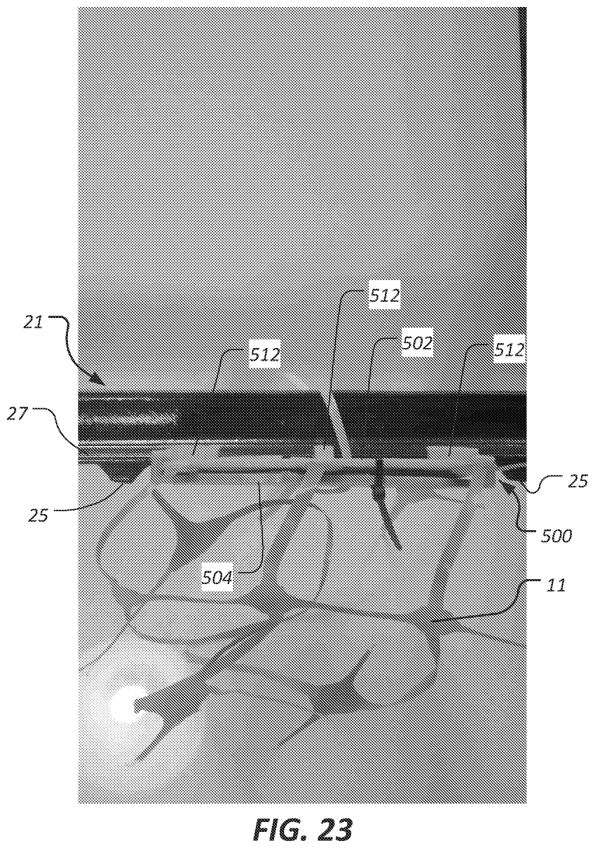

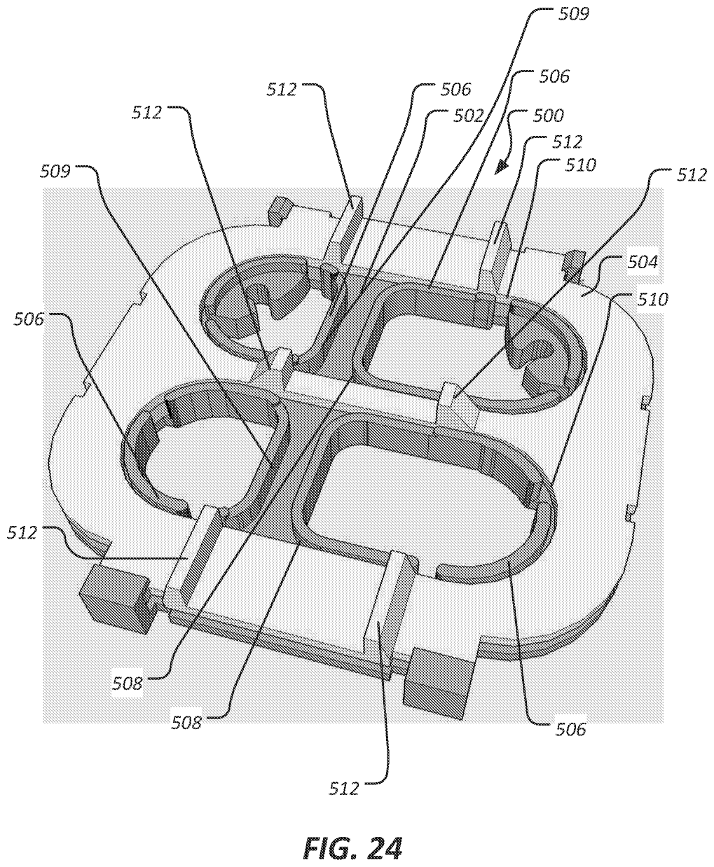

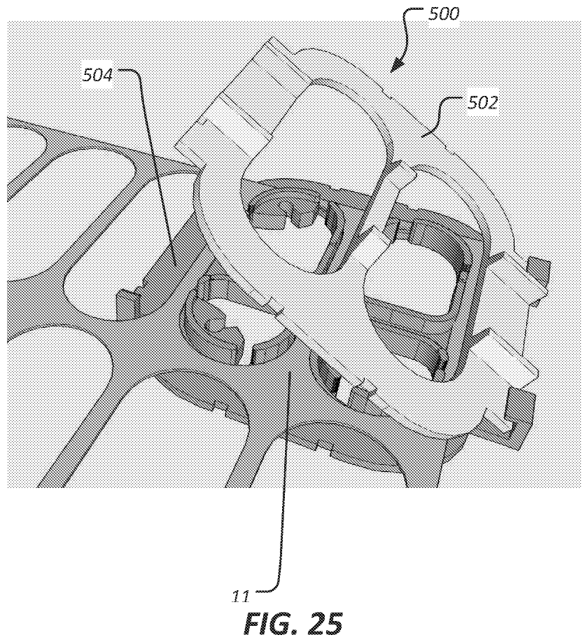

Referring now to FIGS. 17-19, an alternative embodiment of a fence support system 400 is shown. FIG. 17 shows four fence support systems 400 in use with four vertical supports 15 and apertured fence material 11. As shown, the fence support systems 400 can be utilized to provide a departure in angle or direction of fence material so that, as viewed from above, other than straight fences can be supported. As shown, the fence support systems 400 are configured to provide right angle directional changes in apertured fence material 11 captured by the fence support systems 400. In some cases, the fence support systems 400 can be utilized to effectively define an enclosed area within the bounds of the supported apertured fence material 11. The fence support system 400 is substantially similar to fence support systems 100 and 300 insofar as the manner in which apertured fence material is captured within the fence support system 400. More specifically, the fence support system 400 comprises a catch unit 402 and a retainer unit 404. The catch unit 402 generally comprises an inner profile 406 comprising a right angle interface configure for contact with box-shaped vertical supports 15. The catch unit 402 further comprises a curved radius outer profile 408 configured to interface apertured fence material 11. The retainer unit 404 comprises a curved radius inner profile 410 generally complementary to the outer profile 408. The catch unit 402 comprises protrusions 412 shaped generally complementarily to apertures 414 of the retainer unit. The catch unit 402 and the retainer unit 404 may further comprise notches 416 and hooks 418 for selectively retaining the catch unit 402 relative to the retainer unit 404.

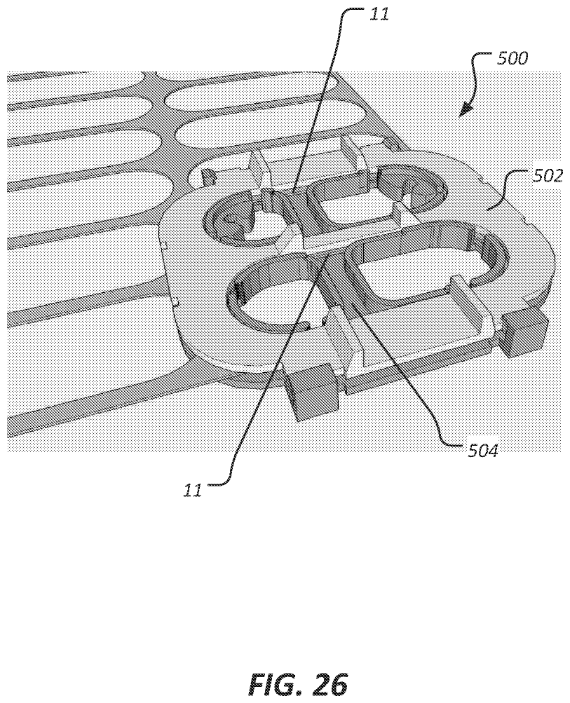

Referring now to FIGS. 20-23, a fence support system 500 is disclosed and shown as capturing fence material 11 and being secured to a T-post 21 using a zip tie fastener 23. FIGS. 24-26 are additional views of the fence support system 500 but without being installed to a T-Post 21. The T-post 21 comprises bumps 25 and edges 27. The fence support system 500 generally comprises an insert member 504 comprising protrusions 506 configured to complement an aperture shape of an apertured safety fence. The fence support system 500 further comprises a clasp member 502 configured to complement the insert member 504 so that the protrusions of the insert member 504 can be securely received and selectively retained within apertures of the clasp member 502. In some embodiments, the protrusion 506 of the insert member 504 can be received through the apertures of an apertured safety fence and further received into the oval-shaped apertures 510 of the clasp member 502 so that the apertured safety fence material 11 is sandwiched or captured between the insert member 504 and the clasp member 502. While the apertures 510 shown are substantially oval-shaped, the protrusions 506 are segmented and form D-shaped profiles, namely, a larger D-shaped profile 508 and a smaller D-shaped profile 509. The fence support system 500 is disclosed as being configured for attachment to a standard T-post 21 that comprises edges 27 and bumps 25. Walls 512 are configured to bound the T-post 21 edges 27 and the bumps 25 can be received through D-shaped apertures formed by the protrusions 506. The system 500 is configured so that when abutted against the T-post 21 with the bumps 25 received through the apertures and edges 202 bound by the walls 512, the system 500 is substantially restrained from movement along the lateral length of the T-post 21 as a function of potential interference with the bumps 25. Operation of the fence support system 500 is substantially similar to operation of fence support system 100.

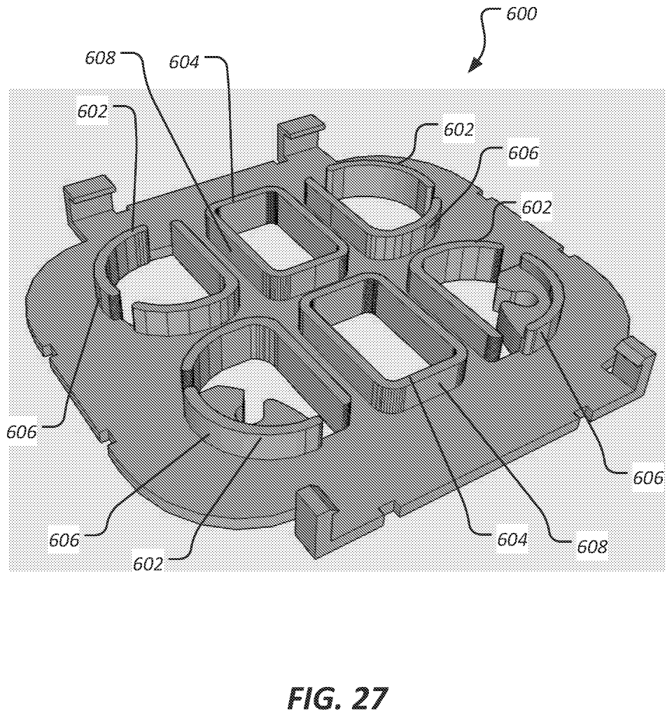

Referring now to FIGS. 27-29, an alternative embodiment of an insert member 600 is shown. The insert member 600 is configured to cooperate with a clasp member substantially similar to clasp member 502. The insert member 600 is substantially similar to the insert member 504, but rather than comprising four D-shaped protrusions, the insert member 600 comprises four similarly sized D-shaped protrusions 602 and two substantially rectangular shaped protrusions 604. The D-shaped protrusions 602 comprise D-shaped profiles 606 and the rectangular shaped protrusions 604 comprise rectangular shaped profiles 608. It will be appreciated that the protrusions 602, 604 can be somewhat segmented to allow for zip tie fasteners or other fasteners to be received through gaps formed in the protrusions 602, 604. While the operation of the insert member 600 is substantially similar to the operation of the insert member 504, the space provided between adjacent protrusions 602, 604 allows for the insert member to more easily receive fence material 11 therebetween that has a complementary configuration, pattern, and/or profile of material/apertures.

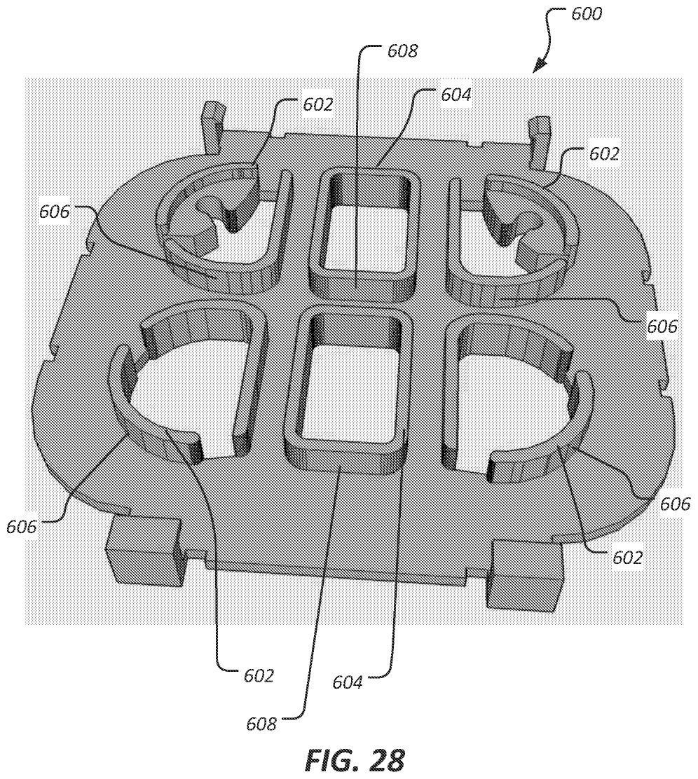

Referring now to FIGS. 30-32, an alternative embodiment of an insert member 700 is shown. Insert member 700 is substantially similar to insert member 504 but has four substantially rectangular shaped protrusions 702 comprising rectangular profiles 704. Insert member 700 further comprises a T-post receiver 706 configured as a concave receptacle for receiving an upper end of a T-post comprising a T-shaped cross-sectional area. The T-post receiver 706 can simultaneously provide a means for mounting the insert member 700 (and/an associated clasp member such as clasp member 502) as well as protect against impalement of people, animals, and/or other objects onto the top of the T-post. The insert member 700 further comprises a blocking plate 708 configured to assist in rebuffing potential impalements on the end of the T-post. It will be appreciated that while the insert member 700 is configured to accommodate a top end of a T-post, in alternative embodiments, an insert member 700 can be configured to receive any other shape into a post receiver or vertical support receiver configured to similarly provide a mounting means and/or an impalement protection means. In an alternative embodiment, the protrusions of the insert member 700 can comprise an at least partially D-shaped protrusion. Also, any of the insert members and/or clasp members can be modified to comprise a vertical support receiver, whether the receiver is configured to receive a T-post or other shaped post and/or vertical support.

It will be appreciated that the terms catch unit and insert member can be used substantially interchangeably herein. It will be further appreciated that the terms retainer unit and clasp member can be used substantially interchangeably. Further, at least three insert members or catch units are disclosed herein that comprise different protrusion shapes and layouts. In some embodiments, the protrusion shapes and/or layouts and/or number of protrusions can be selected to provide enhanced compatibility with fence materials comprising a variety of aperture shapes and layouts. In other words, although specific embodiments are disclosed herein, it is contemplated that any other number, shape, and/or size of protrusions can be provided on an insert member and/or catch unit to better accommodate a fence material having a specialized or different number, shape, and/or size of apertures.

In each embodiment of the fence support systems disclosed herein, at least one of the protrusions of the catch unit or insert member provides a profile comprising a relatively large radius wall surface against which fence material 11 can be pulled against. By distributing the forces along the profile, such as the curved portions of the D-shaped profiles 508, 509, 606, the fence material can be loaded in tension with relatively more force without failing as compared to a much smaller contact surface area, such as, but not limited to, the outer cylindrical surface of a nail or other common fastener utilized to secure fence material 11. In some embodiments, the fence material 11 can be gripped tightly between an insert member and an associated clasp member to distribute tension loads on the fence to the inner facing surfaces of the insert member and clasp member, thereby further increasing tension forces the fence material can withstand without failing (i.e. stretching to failure and/or ripping). In some cases, the protrusion sizes are substantially similarly sized to the size of an aperture of fence material, thereby providing large radii and/or surface area for the fence material to be pulled against without unduly stretching the fence material to accept the protrusion within the apertures of the fence material.

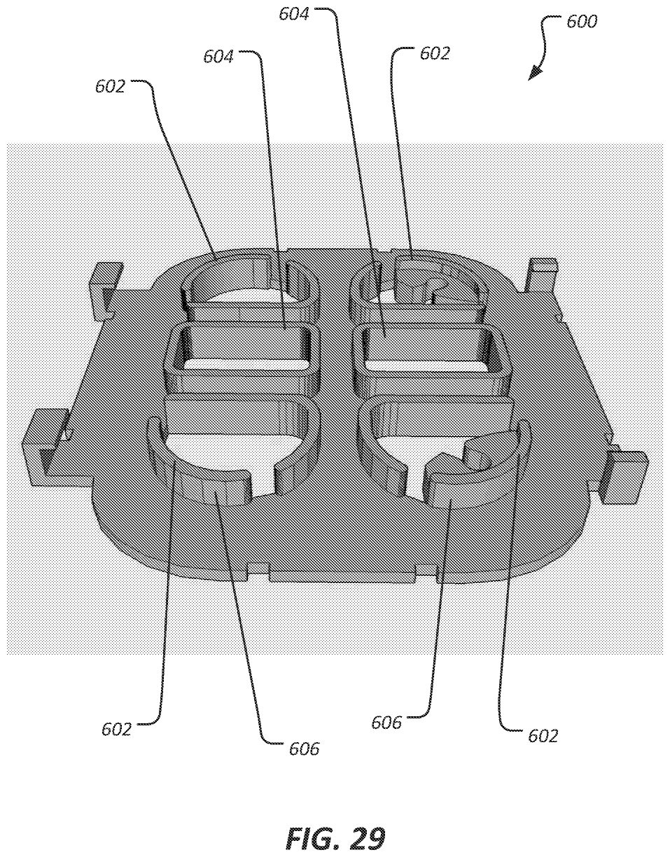

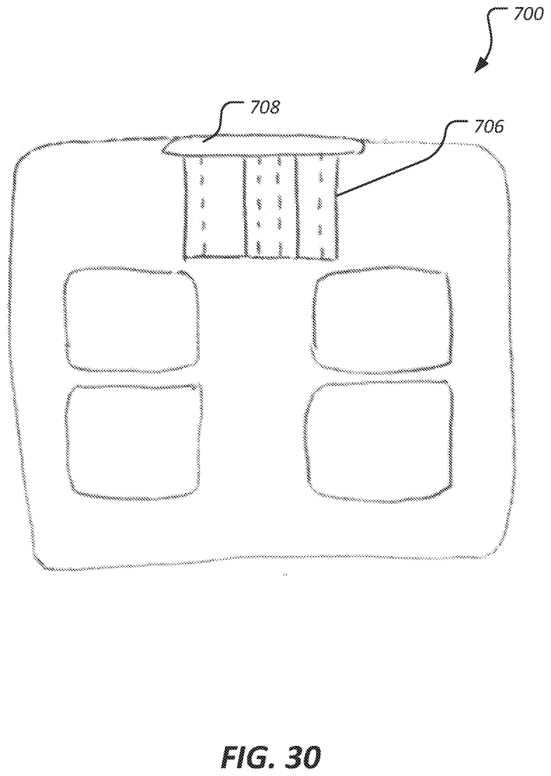

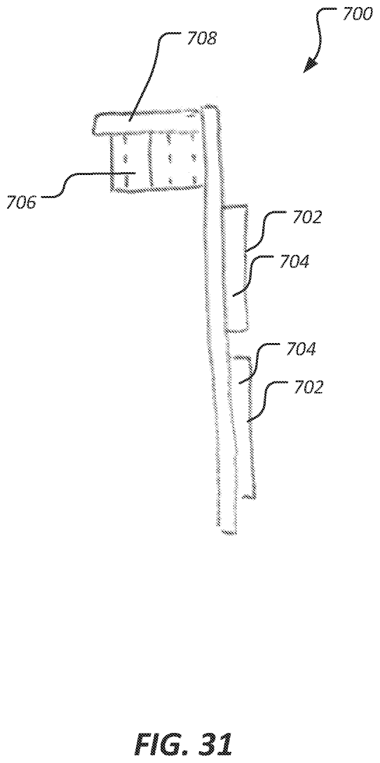

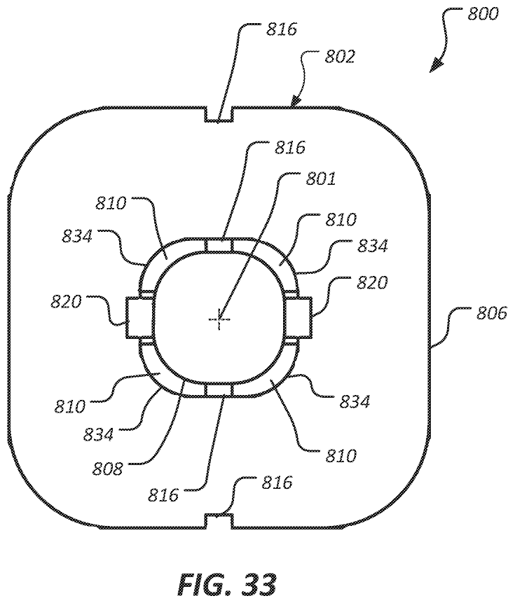

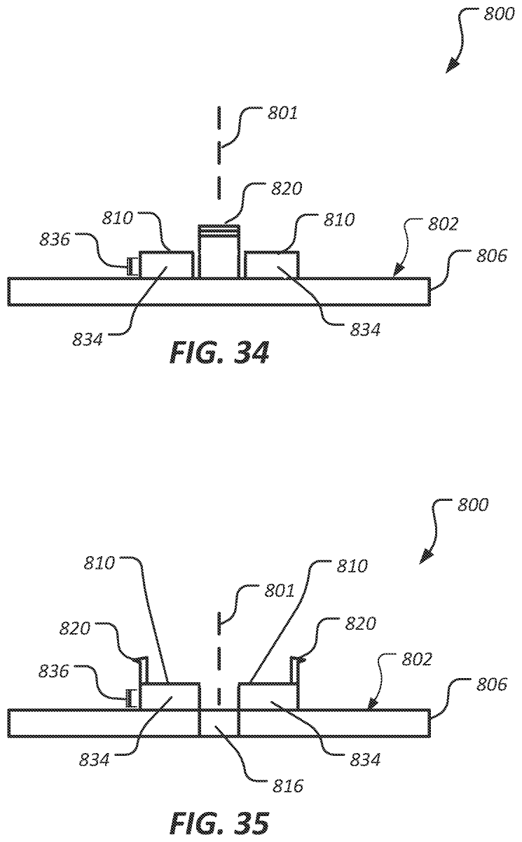

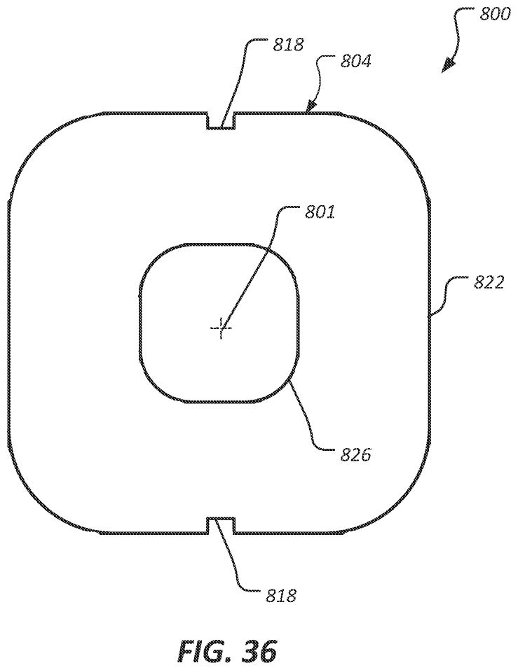

Referring now to FIGS. 33-43, an alternative embodiment of a fence support system 800 is shown. FIGS. 39-43 show the fence support system in use with apertured fence material 11. In this embodiment, the apertured fence material 11 comprises a grid of material pieces that together define apertures through which a portion of the fence support system 800 can extend. In some cases, the apertured fence material 11 may be of the sort commonly referred to as plastic security fencing, safety fencing, and the like. In alternative embodiments, the fence material may comprise any other suitable shape of apertures or arrangement of spacing of apertures relative to each other so that any other suitable matrix, array, or geometric organization of apertures may be provided. In still other embodiments, the apertured fence material may be substantially a solid sheet of material with only so many apertures as necessary to complement the later described protrusions of the fence support system 800. Most generally, the fence support system 800 comprises a catch member 802 and a retainer member 804, configured to selectively retain apertured fence material 11 between the catch member 802 and the retainer member 804. In still other embodiments, the fence support system 800 and other fence support systems disclosed herein may be utilized with solid but flexible fences or other sheets of material that can be received through the retainer member 804 and captured by the fence support system 800 in spite of a lack of apertures in the material. Accordingly, the fence support system 800 can be used to capture at least a portion of the apertured fence material 11 or other material between the catch member 802 and the retainer member 804.

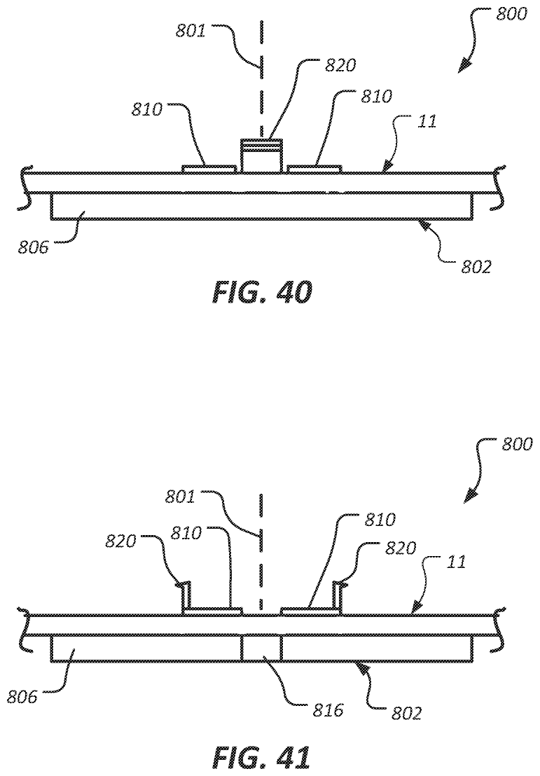

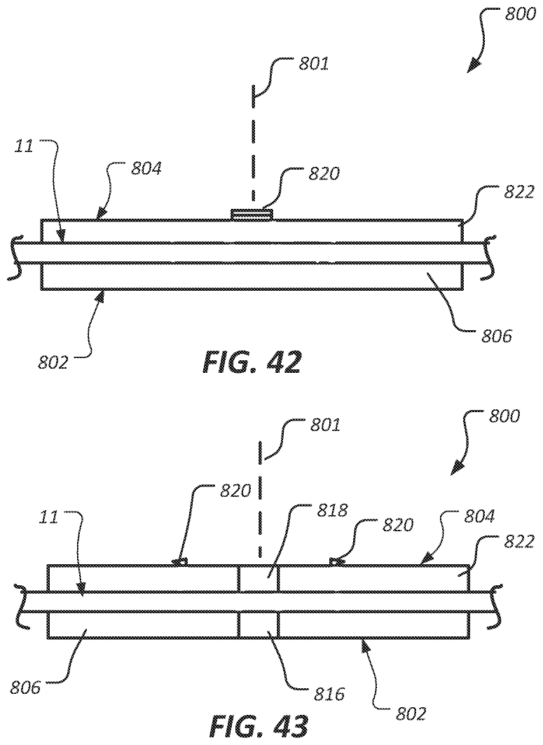

Referring now to FIGS. 33-35, the catch unit 802 is configured to comprise a catch plate 806 comprising an aperture 808. In some cases, the aperture 808 may be shaped complementary to apertures of fence material 11. The catch plate 806 further comprises protrusions 810 sized, shaped, and/or configured relative to each other to complement an aperture of the fence material 11. In this embodiment, the protrusions 810 extend away from the catch plate 806 along an insertion path 801. The protrusions 810 generally comprise raised curved walls that closely border and/or at least partially form a boundary of the aperture 808. In this embodiment, tie notches 816 of the catch member 802 and the complementarily disposed tie notches 818 of the retainer member 804 are provided to accept closure devices, such as, but not limited to, zip ties, wires, string, rope, and the like to provide a primary or secondary selective joinder between the catch member 802 and the retainer member 804. In other words, when catch member 802 and retainer member 804 are mated as shown in FIGS. 42 and 43, zip ties and/or other devices can be passed through geometrically opposing notches 816 and tightened to selectively lock the catch member 802 and retainer member 804 relative to each other. In use, the zip ties and/or other devices would typically be applied after sandwiching apertured fence material 11 between the catch member 802 and the retainer member 804. In this embodiment, the catch member 802 further comprises one or more hooks 820 protruding beyond the catch plate 806. The hooks 820 are generally configured to selectively engage and/or retain a portion of the retainer member 804. In this embodiment, the hooks 820 are formed integrally with the catch plate 806 and are inherently spring biased as a function of the material elasticity of the hooks 820 and catch plate 806.

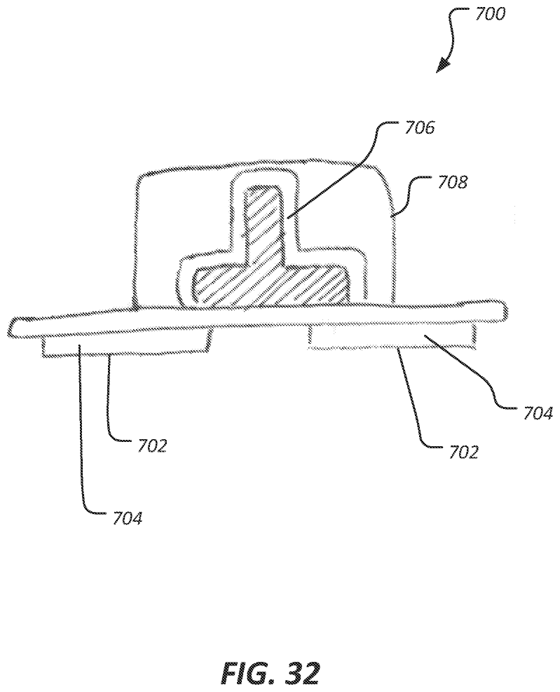

Referring now to FIGS. 36-38, retainer member 804 comprises a retainer plate 822 comprising an aperture 826 configured to receive protrusions 810 therethrough. In alternative embodiments, the protrusions 810 may comprise concave channels formed on an exterior wall of the protrusions 810. In some cases, the concave channels can assist in retaining apertured fence material 11 relative to the protrusions. In other alternative embodiments, the protrusions may comprise features configured to allow one or more of an interference fit between the protrusions 810 and the aperture 826 and a snap fit between the protrusions 810 and the aperture 826, in some cases, thereby reducing any need for the above-mentioned hooks 820.

Referring now to FIG. 39, the fence support system 800 is shown in an unassembled state with apertured fence material 11 located between the catch member 802 and the retainer member 804, but the apertured fence material 11 is not yet captured by the fence support system 800. Upward pointing arrows 828 and downward pointing arrows 830 indicate that the fence support system 800 can be caused to be assembled by moving the catch member 802 upward toward the retainer member 804 and/or by moving the retaining member 804 downward toward the catch member 802 (as viewed in FIG. 39). Importantly, the protrusions 810 are received through an aperture 831 (indicated by hidden lines) of apertured fence material 11 to at least partially capture the apertured fence material 11 using the catch member 802.

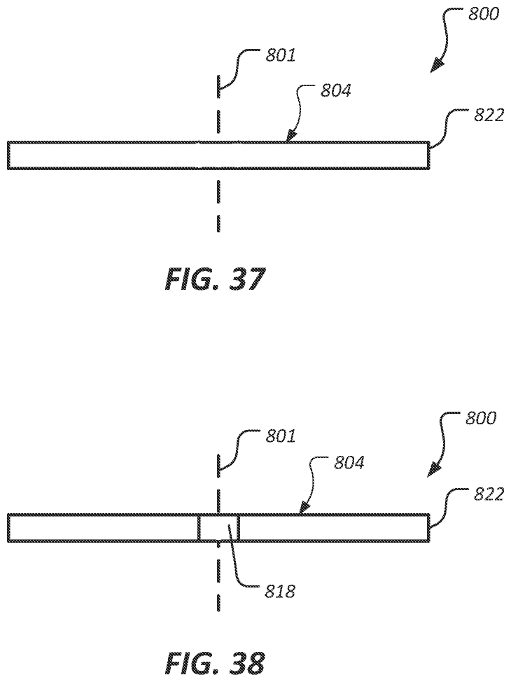

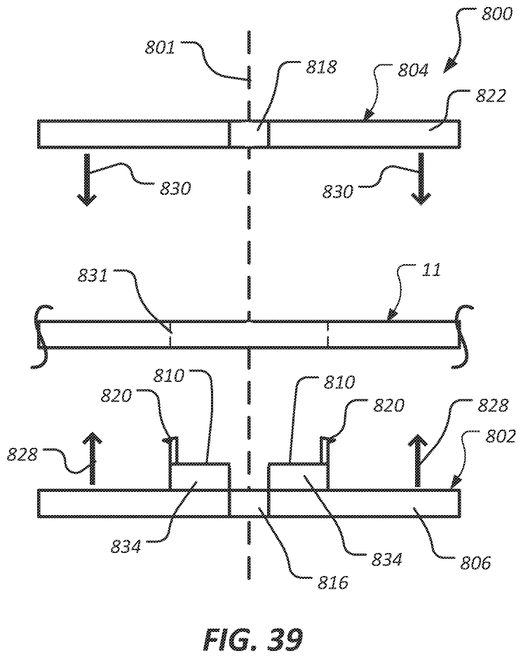

Referring now to FIGS. 40 and 41, the fence support system 800 is shown in a still unassembled state in which the protrusions 810 of the catch member 802 are received through the aperture 831 of the apertured fence material 11. Although such insertion of the protrusions 810 through the aperture 831 may limit movement of the apertured fence material 11 in radial and/or angular directions relative to the insertion path, the apertured fence material may nonetheless be able to move longitudinally away from the catch plate 806. Accordingly, to fully capture the apertured fence material 11, the retainer member 804 can be assembled to the catch member 802.

Referring now to FIGS. 42 and 43, the fence support system 800 is shown in an assembled state in which the apertured fence material 11 is captured by the fence support system 800. In other words, FIGS. 42 and 43 show that the apertured fence material 11 is captured between the catch member 802 and the retainer member 804. Next, the above-described zip ties and/or other devices can be utilized to assist the hooks 820 in retaining the catch member 802 relative to the retainer member 804.

Importantly, fence interface surfaces 834 of the protrusions are angularly curved about the insertion path 801. While the insertion path 801 is substantially orthogonal relative to each of the catch plate 806 and the retainer plate 822, in alternative embodiments, the insertion path may be different while the fence interface surfaces 834 nonetheless maintain some amount of curvature relative to the perimeter of the aperture 831, thereby maintaining a curved surface over which the fence material can be tensioned against. By providing the curved fence interface surfaces 834, apertured fence material 11 can be tensioned against the protrusions 810 with a higher force than would be possible if sharp edges were introduced to the fence material by the protrusions. Further, when the fence support system 800 is assembled, the protrusions 810 can be described as comprising a curved base portion 836 that is not received through the aperture 826, in some cases, due to the thickness of the apertured fence material 11.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A fence support system, comprising:
a catch member comprising a catch plate and a first protrusion and a second protrusion that extend from the catch plate; and
a retainer member comprising a retainer plate comprising a first aperture and a second aperture, the first aperture being configured to receive the first protrusion in response to relative movement of at least one of the catch member and the retainer member along an insertion path and the second aperture being configured to receive the second protrusion;
wherein when the first protrusion is received by the first aperture and when the second protrusion is received by the second aperture, a curved base portion of the protrusion that does not extend through the aperture is located, as determined along the insertion path, between the catch plate and the retainer plate;
wherein the curved base portion is curved angularly about the insertion path; and
wherein some angular orientations of the first aperture about the insertion path relative to some angular orientations of the first protrusion about the insertion path prevent the first protrusion from being received by the first aperture.

2. The fence support system of claim 1, wherein the curved base portion comprises a portion of a fence interface surface of the protrusion.

3. The fence support system of claim 1, wherein the insertion path is substantially orthogonal to the catch plate.

4. The fence support system of claim 1, wherein the insertion path is substantially orthogonal to the retainer plate.

5. The fence support system of claim 1, wherein the insertion path is substantially orthogonal to at least one of the catch plate and the retainer plate and extends through the aperture of the retainer plate.

6. The fence support system of claim 1, wherein the catch member comprises a tie notch configured to receive a closure device.

7. The fence support system of claim 1, wherein the retainer member comprises a tie notch configured for alignment with a tie notch of the catch member when the retainer member is substantially mated with the catch member.

8. The fence support system of claim 1, wherein the retainer member comprises only one aperture configured to receive the protrusion of the catch member.

9. The fence support system of claim 1, wherein the retainer member is configured for selective mating to the catch member so that an apertured fence material can be captured between the retainer plate and the catch plate.

10. The fence support system of claim 9, wherein when the retainer member is mated to the catch member, at least a portion of the first protrusion of the catch member is received within the first aperture of the retainer member.

11. The fence support system of claim 10, wherein when the retainer member is mated to the catch member and an apertured fence material is captured between the retainer plate and the catch plate, the first protrusion is configured to extend through a first aperture of the apertured fence material and the second protrusion is configured to extend through a second aperture of the apertured fence material.

12. The fence support system of claim 1, wherein at least one of the first protrusion and the second protrusion is tubular.

13. A fence support system, comprising:
a catch member comprising a catch plate and a protrusion that extends from the catch plate; and
a retainer member comprising a retainer plate comprising an aperture, the aperture being configured to receive the protrusion in response to relative movement of at least one of the catch member and the retainer member along an insertion path;
wherein when the protrusion is received by the aperture, a curved base portion of the protrusion that does not extend through the aperture is located, as determined along the insertion path, between the catch plate and the retainer plate;
wherein the curved base portion is curved angularly about the insertion path;
wherein the protrusion is tubular; and
wherein some angular orientations of the first aperture about the insertion path relative to some angular orientations of the first protrusion about the insertion path prevent the first protrusion from being received by the first aperture.

14. The fence support system of claim 13, wherein the catch member further comprises a second protrusion and the retainer member further comprises a second aperture, the second aperture being configured to selectively receive the second protrusion.

15. The fence support system of claim 14, wherein the second protrusion is tubular.

16. A fence support system, comprising:
a catch member comprising a catch plate and a first protrusion and a second protrusion that extend from the catch plate; and
a retainer member comprising a retainer plate comprising a first aperture and a second aperture, the first aperture being configured to receive the first protrusion in response to relative movement of at least one of the catch member and the retainer member along an insertion path and the second aperture being configured to receive the second protrusion;
wherein when the first protrusion is received by the first aperture and when the second protrusion is received by the second aperture, a curved base portion of the protrusion that does not extend through the aperture is located, as determined along the insertion path, between the catch plate and the retainer plate;
wherein the curved base portion is curved angularly about the insertion path; and
wherein the curved base portion is at least one of (1) not symmetrical about the insertion path and (2) discontinuous about the insertion path.
